(19) United States
(12) Patent Application Publication
(10) Pub. No.: US 2026/0019572 A1
(43) Pub. Date: Jan. 15, 2026

(54) VIDEO IN-LOOP FILTER ADAPTIVE TO VARIOUS TYPES OF NOISE AND CHARACTERISTICS

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 18/994,221

(22) PCT Filed: Jun. 22, 2023
(86) PCT No.: PCT/KR2023/008669

§ 371 Date: Jan. 14, 2025

(30) Foreign Application Priority Data
Jul. 20, 2022 (KR) 10-2022-0089497
Jun. 21, 2023 (KR) 10-2023-0079502

(51) Int. Cl. H04N 19/117; G06N 3/045; G06N 3/08; H04N 19/105; H04N 19/176; H04N 19/82

(52) U.S. Cl. CPC H04N 19/117; G06N 3/045; G06N 3/08; H04N 19/105; H04N 19/176; H04N 19/82

(57) ABSTRACT

A video coding method and device using an in-loop filter adaptive to various types of noise and characteristics. The video decoding device generates an output block by inputting a reconstruction block for a current block to a deep learning-based in-loop filter. The video decoding device selects a block for retaining the in-loop filter from the reconstruction block and retrains the in-loop filter using the selected reconstruction block and a target block.

### CROSS-REFERENCE TO RELATED APPLICATIONS

This application is a U.S. national stage of International Application No. PCT/KR2023/008669, filed on Jun. 22, 2023, which claims priority to Korean Patent Application No. 10-2022-0089497, filed on Jul. 20, 2022, and Korean Patent Application No. 10-2023-0079502, filed on Jun. 21, 2023, the entire contents of each of which are hereby incorporated herein by reference.

### TECHNICAL FIELD

The present disclosure relates to a video coding method and an apparatus using an in-loop filter adaptive to various types of noise and characteristics.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Recently, deep learning-based image processing technology is being applied to existing encoding component technology. By applying deep learning-based image processing technology to compression techniques, such as inter prediction, intra prediction, in-loop filtering, and transformation, among existing encoding techniques, coding efficiency may be improved. Representative applications include virtual reference frame-based inter prediction generated based on deep learning and in-loop filtering based on a noise removal model.

Meanwhile, an in-loop filter based on a noise removal model may provide excellent compression noise removal performance because in-loop filter is trained under the assumption that the image quality of input images in both training and real-world environments is similar to each other. However, when general supervised learning is applied to a noise removal model, the performance of the in-loop filter may decrease as the difference between the training image quality and the verification image quality increases. Therefore, to improve video encoding efficiency and video image quality, it is necessary to consider a method for adaptively removing compression noise on the decoder side for videos with varying image quality and characteristics.

### SUMMARY

The present disclosure seeks to provide a video coding method and an apparatus which decode videos using a pre-trained, deep learning-based in-loop filter. At this time, the video coding method and the apparatus retrain the in-loop filter on the decoder side by using video samples selected during the video decoding process and then reconstruct the video by using the retrained in-loop filter.

At least one aspect of the present disclosure provides a method for reconstructing a current block, performed by a video decoding device. The method includes generating a reconstruction block for the current block from a bitstream. The method also includes generating an output block by inputting the reconstruction block to a deep learning-based in-loop filter. Here, the in-loop filter is pre-trained to generate an output that approximates original block from the reconstruction block. The method also includes selecting a block for retaining of the in-loop filter from the reconstruction block. The method also includes retraining the in-loop filter by using the selected reconstruction block and a target block.

Another aspect of the present disclosure provides a method for encoding a current block, performed by a video encoding device. The method includes generating a reconstruction block for the current block. The method also includes generating a first output block by inputting the reconstruction block to a deep learning-based in-loop filter. Here, the in-loop filter is pre-trained to generate an output that approximates original block from the reconstruction block. The method also includes selecting a block for retaining of the in-loop filter from the reconstruction block. The method also includes retraining the in-loop filter by using the selected reconstruction block and a target block. The method also includes generating a second output block by inputting the selected reconstruction block to the retrained in-loop filter.

Yet another aspect of the present disclosure provides a computer-readable recording medium storing a bitstream generated by a video encoding method. The video encoding method includes generating a reconstruction block for a current block. The video encoding method also includes generating a first output block by inputting the reconstruction block to a deep learning-based in-loop filter. Here, the in-loop filter is pre-trained to generate an output that approximates original block from the reconstruction block. The video encoding method also includes selecting a block for retaining of the in-loop filter from the reconstruction block. The video encoding method also includes retraining the in-loop filter by using the selected reconstruction block and a target block. The video encoding method also includes generating a second output block by inputting the selected reconstruction block to the retrained in-loop filter.

As described above, the present disclosure provides a video coding method and an apparatus that retrain a deep learning-based in-loop filter on the decoder side by using video samples selected during a video decoding process and then reconstruct a video by using the retrained in-loop filter. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 illustrates operations in the convolution layer.

FIG. 7 illustrates a single image super resolution (SISR) network.

FIG. 8 illustrates a residual block used in the SISR network.

FIG. 9 illustrates a fixed coefficient in-loop filter based on a convolutional neural network (CNN).

FIG. 10 illustrates the shape of an adaptive loop filter (ALF).

FIG. 11 illustrates a block diagram of a video decoding device according to one embodiment of the present disclosure.

FIG. 12 illustrates the operation of a deep learning-based in-loop filter according to one embodiment of the present disclosure.

FIG. 13 illustrates retraining of a deep learning module according to one embodiment of the present disclosure.

FIG. 14 illustrates retraining of a deep learning module according to another embodiment of the present disclosure.

FIG. 15 is a flow diagram illustrating a method for encoding a current block performed by a video encoding device according to one embodiment of the present disclosure.

FIG. 16 is a flow diagram illustrating a method for reconstructing a current block performed by a video decoding device according to one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

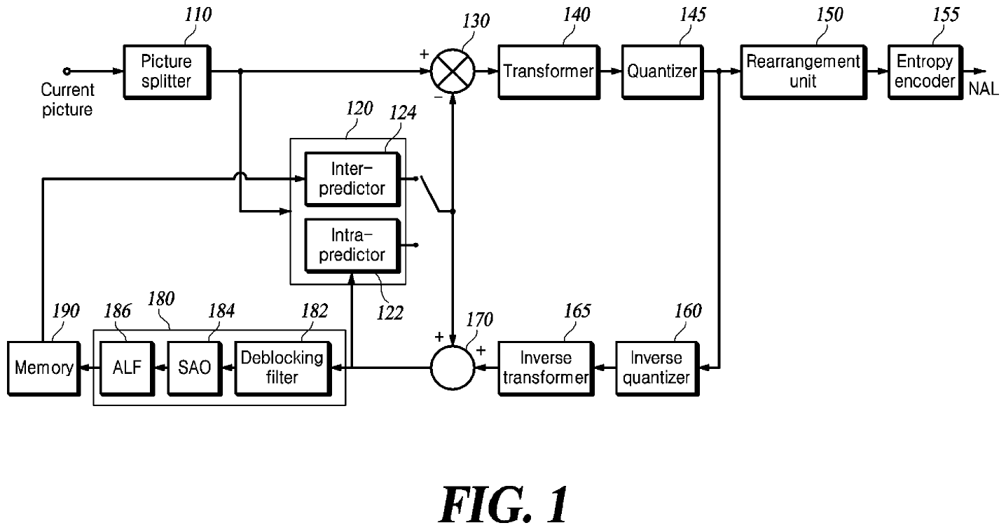

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

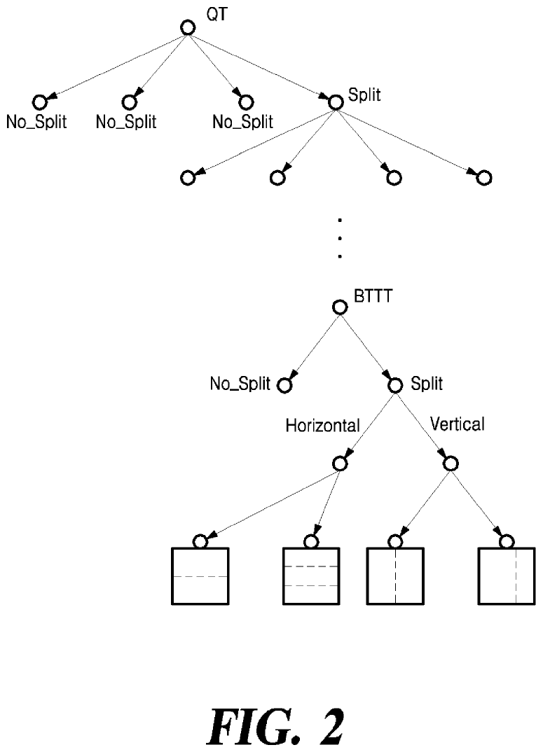

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

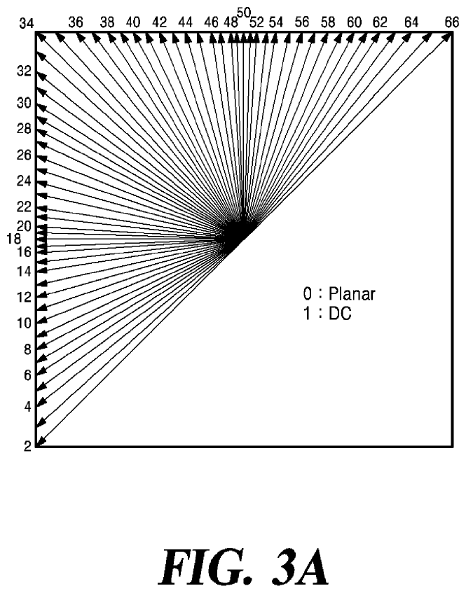

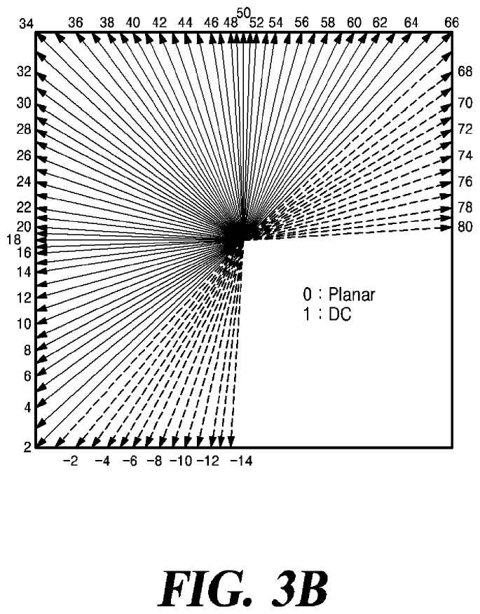

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

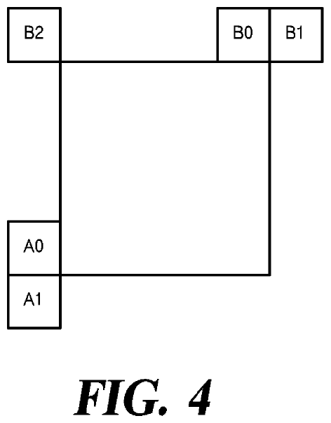

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate.

Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

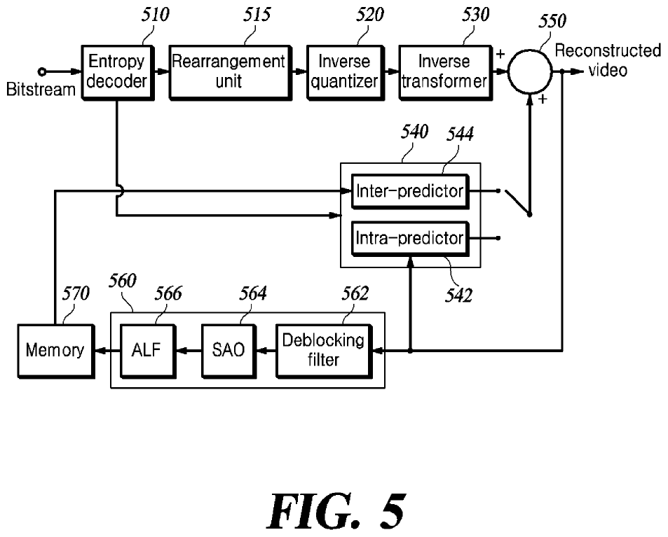

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that decode a video using a pre-trained, deep learning-based in-loop filter. At this time, the video coding method and the apparatus retrain the in-loop filter on the decoder side by using video samples selected during the video decoding process and then reconstruct the video by using the retrained in-loop filter.

The following embodiments may be performed by various constituting elements in the video encoding device. The following embodiments may also be performed by various constituting elements in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. CONVOLUTIONAL NEURAL NETWORK (CNN)

A CNN refers to a type of neural network composed of a plurality of convolution and pooling layers, which is a deep learning approach known to be most suitable for image processing. The convolution layer extracts feature maps (also referred to as “features”) using a plurality of kernels or filters. At this time, kernel coefficients that make up the filters are parameters determined during the learning process.

Among the convolution layers of CNN, the front layers close to the input extract feature maps that respond to simple, lower-level image features such as lines, points, or surfaces, while the rear layers close to the output extract feature maps that respond to higher-level image features such as texture and object parts.

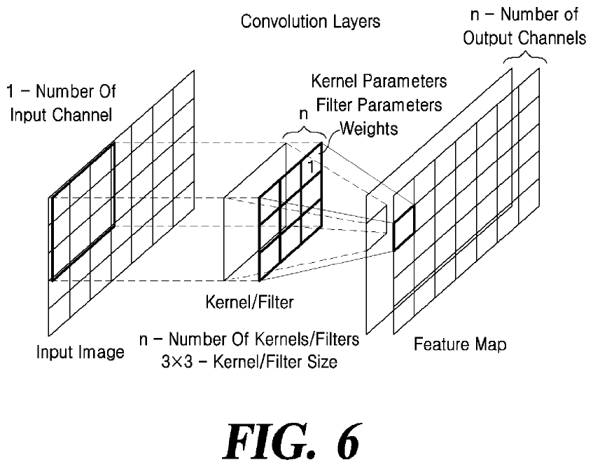

FIG. 6 illustrates operations in the convolution layer according to one embodiment of the present disclosure.

A convolution layer generates a feature map from an input image using a convolution operation. The example of FIG. 6 illustrates a kernel (or a filter) with a kernel size of 3×3. The kernel size is also referred to as a filter size. The kernel has kernel parameters or filter parameters, which are alternatively called weights. The kernel shown in FIG. 6 has a total of 9 kernel parameters. The kernel parameters are initially set to arbitrary values, which are updated through training.

The convolution layer performs a convolution operation using a block of the input image, which matches the kernel size. At this time, the block of the kernel size in the input image is referred to as a window.

When filtering is performed on the input image in a raster-scan order, the movement size of the window is called a stride. In the example of FIG. 6, the stride is 1. If the stride is set to 2, the convolution operation is performed by moving the window in fixed increments of 2 samples, and as a result, the width and height of the feature map become half of the width and height of the input image.

As described above, one convolution layer may include a plurality of filters. The number of filters or the number of kernels is called a channel. In other words, the number of channels is the same as the number of filters. Also, the number of filters determines the size of the dimensions of the feature map.

Padding refers to a method of expanding input data by filling the neighborhood of the input data with a specific value before performing the convolution operation. Padding is mainly used to adjust the spatial size of output data. The value used for padding may be determined by hyperparameters, but zero-padding is commonly used. If padding is not used, the spatial dimensions of output data decreases after each convolution layer, which may result in a loss of boundary information. Therefore, padding is applied to prevent the boundary problem. In other words, padding may be used to match the spatial sizes of the output data and the input data of the convolution layer.

The deconvolution layer performs the opposite operation to the convolution layer. The deconvolution layer generates the desired data image as output from the input feature map.

The pooling layer performs pooling, which is a process of sub-sampling the feature map generated by the convolution layer. The pooling layer selects samples using a 2×2 window so that the output result is half the width and height of the input. In other words, the pooling layer is used to reduce the size of the input image or input feature map by condensing the 2×2 area into a single sample.

The unpooling layer is the opposite concept of the pooling layer. The unpooling layer serves to expand the dimensions, in contrast to the pooling layer, and is mainly used after the deconvolution layer.

The convolutional encoder-decoder structure is a network structure composed of pairs of convolution and deconvolution layers. The convolutional encoder consists of convolution and pooling layers and outputs a feature map (or feature vector) from the input image. The final output vector of the convolutional encoder is also referred to as a latent vector. The convolutional decoder consists of deconvolution and unpooling layers and generates an output image from the feature map or latent vector.

The input and output of the convolutional encoder-decoder may be set in various ways depending on the purpose of the application and network. For example, the input and output may be an optical flow map, a saliency map, an image frame, and the like.

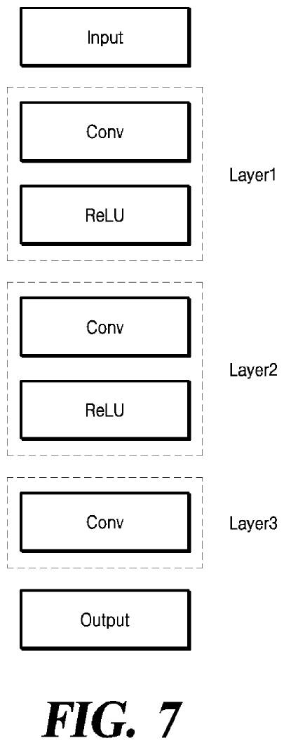

FIG. 7 illustrates an SISR network.

An application example of a CNN is Single Image Super Resolution (SISR). The SISR network generates a high-resolution image as output from a low-resolution input image. The SISR network may include a plurality of convolution layers, as illustrated in FIG. 7. Each convolution layer includes an activation function such as the Rectified Linear Unit (ReLU). The parameters of the SISR network may be trained so that the generated Super Resolution (SR) image approaches the ground truth (GT).

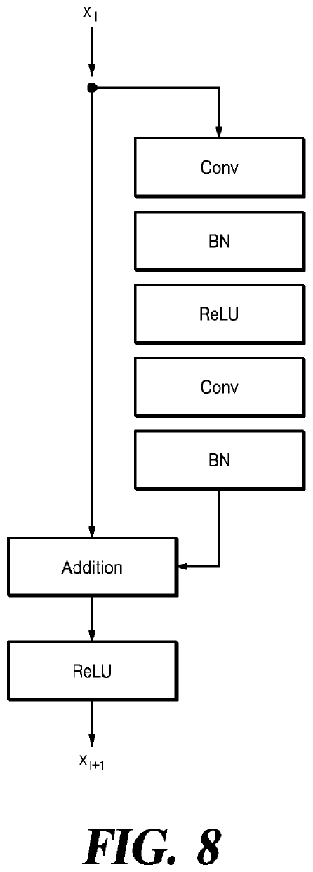

SR methods using CNN may improve the SR performance by increasing the depth (e.g., increasing the number of convolution layers). To overcome the overfitting problem during training, which may occur from increase of the network depth, a residual block capable of performing skip connection and residual learning may be used in the SISR network. The residual block includes a skip path in addition to the path that applies the convolution operation to the input feature x₁, as illustrated in FIG. 8. Also, the residual block may select the path or the skip path that applies the convolution operation based on learning efficiency when generating the output x₁₊₁.

In the example of FIG. 8, the residual block includes a Batch Normalization (BN) layer.

For example, Enhanced Deep residual networks for SISR (EDSR) increases the performance of the network by continuously connecting residual blocks to increase the network depth. In another example, Accurate Image Super-Resolution Using Very Deep Convolutional Networks (VDSR) is a CNN model based on the Visual Geometry Group (VGG) network, which uses residual learning, which adds residual frames to the final output. VDSR adds residual signals to the input signal by adding the residual signals to the very end of the network.

In another example, CNN may be used as an in-loop filter in the video encoding device or video decoding device. In this case, the deep learning-based in-loop filter may be applied to any location within the existing loop filter unit 180, 560 consisting of a deblocking filter, an SAO filter, and an ALF.

A fixed coefficient in-loop filter is a type of deep learning-based in-loop filter. The fixed coefficient deep learning in-loop filter uses the same CNN kernel parameters stored in both the video encoding device and video decoding device.

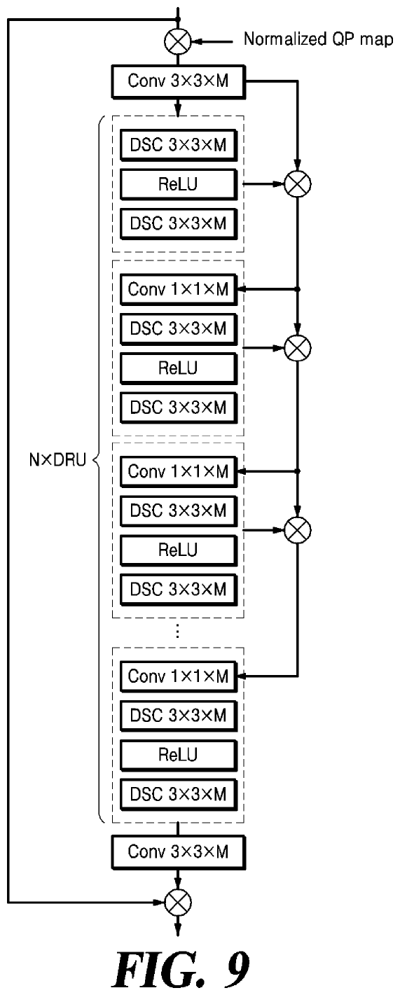

FIG. 9 illustrates a fixed coefficient in-loop filter based on a convolutional neural network (CNN).

The input block (or input frame) is passed through a normalized QP map and then passed to the subsequent stage. The normalized QP map is used to reduce inference errors when quantization noises of different intensities are mixed during the learning and inference processes.

The same set of kernel parameters that constitute the Dense Residual Unit (DRU) and the convolution layer may be used by being stored in both the video encoding device and the video decoding device. In the example of FIG. 9, each DRU may include all or part of the convolution layers, the ReLU layers, and the depth-wise separable convolutional (DSC) layers.

Since the fixed-coefficient deep learning in-loop filter has to provide consistent performance across various video frames, it exhibits a disadvantage that the number of CNN layers increases and the computation time increases accordingly.

### II. SUPERVISED LEARNING AND SELF-SUPERVISED LEARNING

In training a deep learning network, supervised learning is a type of learning method that uses label information. At this time, the process of calculating weights based on training data and labels is called training. Training may usually be performed using the stochastic gradient descent (SGD) algorithm that employs the back propagation algorithm. The process of calculating outputs in the feed-forward direction using weights, which are parameters calculated according to training, is called inference or testing.

Self-supervised learning is a type of learning method that uses only image information without using label information of data and trains a deep learning network using only training data without involving an expensive annotation process. For a deep learning network that learns feature representation using large-scale image data, self-supervised learning may improve the performance of the deep learning network by applying very simple tuning to a specific task or domain.

Contrastive learning is a self-supervised learning technique. In contrastive learning, two samples are configured as a pair, and then the configured pair is used as the input for a deep learning network. In contrastive learning, training is performed based on the similarity of the two samples that constitute the pair. In other words, if the two samples are different, they are configured as a negative pair, while, if the two samples are similar, they are configured as a positive pair; the configured pairs are then used for training. Since including all negative pairs excessively increases the complexity of training, contrastive learning aims to appropriately select pairs that are useful for training.

For example, after generating two similar images by applying different data augmentations to a single image, a pair of the two generated images may be configured as a positive pair. Also, the pair generated by combining different images may be configured as a negative pair. Contrastive learning performs self-supervised learning without involving any supervised learning by training a deep learning network using the InfoNCE loss function. Here, NCE stands for noise contrastive estimation. The InfoNCE loss function LN is defined as Equation 1 based on the ratio of the similarity of a positive pair to the sum of the similarity of the positive pair and the similarities of negative pairs.

$${L}_{N} = - {E}_{x} [ log \frac{exp ( {f ( x )}^{T} f ( {x}^{+} ) )}{exp ( {f ( x )}^{T} f ( {x}^{+} ) ) + {\sum }_{j = 1}^{N - 1} exp ( {f ( x )}^{T} f ( {x}_{j}^{-} ) )} ] \qquad [ Equation 1 ]$$

Here, exp(f(x)^{T}f(x⁺)) represents the similarity of a positive pair, and exp(f(x)^{T}f(x⁻)) represents the similarity of a negative pair. f(x) models the representation of each image included in the positive pair or the negative pair, namely, the output of the deep learning network used. Contrastive learning trains a deep learning network in a direction of reducing the InfoNCE loss function by increasing the similarity of the positive pair.

### III. ADAPTIVE LOOP FILTER (ALF)

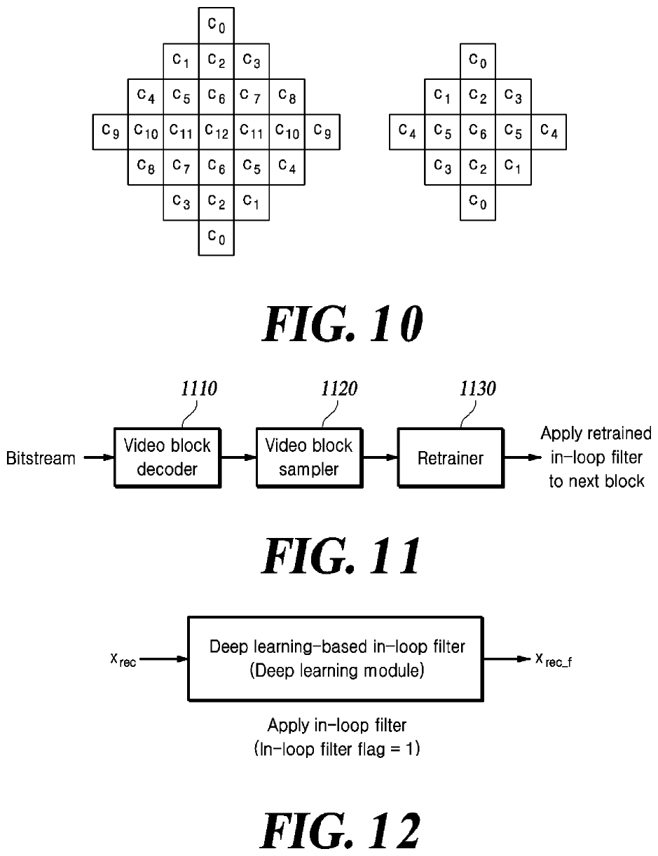

The ALF 186, 566 of VVC approximates a reconstructed video frame to its original by using an adaptive linear filter based on the Wiener-Hopf equation. The video encoding device calculates the filter coefficients of the ALF 186 according to the rate-distortion optimization using the output samples of SAO 184 and then transmits the calculated filter coefficients to the video decoding device. The ALF 186, 566 is configured as a 7×7 diamond shape and a 5×5 diamond shape as shown in the example of FIG. 10 and is used for luma and chroma samples, respectively. The filter shape and size may be determined by considering the balance between coding efficiency and computational complexity. For example, the computational complexity of ALF 186, 566 may be reduced by using a symmetric FIR filter.

To derive the filter coefficient ci shown in FIG. 10, samples at the corresponding positions are used. The filtered sample I_{f}(x,y) at the current location (x,y) may be calculated by Equation 2 based on a 7-bit precision operation.

$${I}_{f} ( x , y ) = I ( x , y ) + [ ( {\sum }_{i = 0}^{N - 2} {c}_{i} {r}_{i} + 64 ) ≫ 7 ] \qquad [ Equation 2 ]$$

Here, N represents the number of filter coefficients. rᵢ represents a difference between the current sample and its neighboring sample, which is calculated by Equation 3.

$${r}_{i} = min ( {b}_{i} , max ( - {b}_{i} , I ( x + {x}_{i} , y + {y}_{i} ) - I ( x , y ) ) ) + min ( {b}_{i} , max ( - {b}_{i} , I ( x - {x}_{i} , y - {y}_{i} ) - I ( x , y ) ) ) \qquad [ Equation 3 ]$$

In Equation 3, bᵢ represents the clipping parameter.

The ALF 186, 566 uses up to 25 filter coefficient sets for the luma component and applies the 25 filter coefficient sets to 4×4 sub-blocks. According to the gradient information of the local block calculated using the Laplacian filter, the 4×4 sub-blocks are classified into one of 25 classes. Specifically, the classification index for the class is derived from a combination of five directional attributes expressing the intensity and direction of the texture component and five activity attributes of the sub-block. Also, geometric transforms such as 90-degree rotation, diagonal transform, and vertical transform may be applied to the filter coefficients before filtering. By considering various directionality using geometric transforms, more diverse block characteristics may be processed using a smaller number of filter coefficient sets.

In addition to the sub-block unit, whether to apply the ALF may be determined based on the CTU unit. In the case of chroma component, up to eight filters are used at the CTU level. The chroma ALF may be activated only when the luma ALF is activated at the corresponding level.

Meanwhile, an Adaptation Parameter Set (APS) is used to transmit ALF filter parameters including a set of filter coefficients. As described above, up to 25 sets of filter coefficients may be calculated for the luma component, and up to 8 sets of filter coefficients may be calculated for the chroma component. When the same ALF coefficients are used for different slices, the index of the reference APS may be signaled instead of retransmitting the same ALF coefficients.

In video applications based on, for example, High-Dynamic Range (HDR) and Wide Color Gamut (WCG), reconstruction of video colors is very important. Cross-Component ALF (CC-ALF) modifies chroma samples in parallel with ALF using the correlation between the current chroma sample and the luma sample at the corresponding position.

The following embodiments are described with respect to a video decoding device but may also be performed by a video encoding device.

### IV. EMBODIMENTS ACCORDING TO THE PRESENT DISCLOSURE

As described above, the deep learning-based in-loop filter integrated within the video decoding device is pre-trained based on a substantial volume of training data. After the training is completed, the same deep learning module is installed in the in-loop filter of both the video encoding device and the video decoding device. The deep learning module performs video compression after sufficiently removing quantization noise in general images. At this time, as described above, the deep learning module may be pre-trained to generate an output that approximates the original sample from a video sample mixed with quantization noise after compression. The deep learning module may be used in both the video encoding device and the video decoding device with its parameters fixed during operation.

In the followings, the deep learning-based in-loop filter and the deep learning module are used interchangeably. The video sample represent a selected or sampled video block and may be used interchangeably with the video block.

However, the filter performance of the deep learning module may be affected depending on the characteristics of video samples used for training. For example, if a video sample having a feature that is not used in the training process is input, the filter performance may deteriorate. In the video compression process, the statistical characteristics of the input video sample may vary based on the strength of the quantization noise and attributes of the sensor used during video production/generation. To solve the performance degradation problem, the present embodiment utilizes self-supervised learning on the decoder side by using the video samples generated during the video decoding process.

FIG. 11 is a block diagram of a video decoding apparatus according to one embodiment of the present disclosure.

The video decoding device according to the present embodiment may include all or part of a video block decoder 1110, a video block sampler 1120, and a retrainer 1130, in addition to the constituting elements illustrated in FIG. 5.

The video block decoder 1110 reconstructs a video block from a bitstream. To reconstruct the video block, the video block decoder 1110 may include all or part of the constituting elements illustrated in FIG. 5. The video block decoder 1110 generates a video block to be provided as an input to a deep learning-based in-loop filter.

The video block sampler 1120 selects a video block for retraining among the video blocks provided from the video block decoder 1110 to apply decoder-side retraining to the deep learning module.

The retrainer 1130 updates the parameters of the deep learning module on the decoder side by using the selected video block. The video decoding device may apply the retrained deep learning module to the in-loop filtering of the next block.

Even though the video encoding device has the original video sample, the present embodiment may also be applied to the decoder side of the video encoding device. To perform the same operation as the decoder side of the video decoding device, the video encoding device may perform the same operation as the example of FIG. 11 on the decoder side. Here, the decoder side of the video encoding device may include the predictor 120, the inverse quantizer 160, the inverse transformer 165, the adder 170, the loop filter unit 180, and the memory 190 among the constituting elements of FIG. 1.

In the followings, a method for the video block sampler 1120 to sample a retraining video block of a deep learning-based in-loop filter is described.

The video encoding device may select a block that utilizes the in-loop filter to optimize rate-distortion. For example, the conventional deep learning-based in-loop filter as described above is applied in video block or slice units. When a deep learning-based in-loop filter is used, the video encoding device sets a flag (in what follows, “in-loop filter flag”) indicating whether to use the in-loop filter to 1 and then transmits the in-loop filter flag to the video decoding device. If the decoded in-loop filter flag is 1, the video decoding device applies the deep learning-based in-loop filter to improve the video image quality of the corresponding block. On the other hand, if the decoded in-loop filter flag is 0, the video decoding device does not apply the deep learning-based in-loop filter to the corresponding block.

The ALF technique in VVC also controls whether to apply the ALF 566 using a block-unit or slice-unit flag (in what follows, “ALF flag”). In other words, the video decoding device may determine whether to apply the ALF 566 to the corresponding block according to a received flag.

For example, if the in-loop filter flag is true, the deep learning-based in-loop filter in the video decoding device generates an improved output x_{rec_f} from the decoded sample x_{rec}, as in the example of FIG. 12. At this time, the video block sampler 1120 may update the parameters of the in-loop filter by using the current sample x_{rec} for retraining for the next input video signals. Alternatively, the improved in-loop filter may also be used for the current sample.

In another example, the video block sampler 1120 may determine whether to sample the corresponding block according to the parameters used for compression of the video block. For example, if the height and width of a block are smaller than a predetermined threshold, the block may be used for retraining. Alternatively, if the quantization parameters of the block are larger or smaller than a predetermined threshold, the corresponding block may be used for retraining.

In another example, the video encoding device may signal a sample for which retraining is applied or a video signal range to the video decoding device.

In another example, a separate, trained discriminator may be used. The video block sampler 1120 may input a decoded block to the discriminator and determine whether to use the corresponding block for retraining based on the output of the discriminator.

Meanwhile, the video encoding device may control the retraining in the video decoding device using a flag (hereafter, “retraining flag”) indicating whether to perform retraining. Depending on whether the encoding efficiency may be improved by updating the deep learning module using video samples available on the decoder side, the video encoding device may set the value of the retraining flag. At this time, if the retraining flag is 0 in slice units or block units, the video decoding device does not perform retraining of the deep learning module but determines whether to apply the deep learning module based on the in-loop filter flag. On the other hand, if the retraining flag is 1, the video decoding device may perform retraining of the deep learning module. At this time, the in-loop filter flag also has to be 1. In other words, if the in-loop filter flag is true and the retraining flag is true, the video decoding device may perform retraining of the deep learning module.

As described above, instead of updating the parameters of the deep learning module using the original image and then transmitting the corresponding parameters, the video encoding device determines whether to use the updated parameters on the decoder side. Also, the video encoding device may set the value of the retraining flag according to the determination result and then signal the retraining flag to the video decoding device.

In the followings, a method for the retrainer 1130 to retrain a deep learning-based in-loop filter is described.

As described above, if both the in-loop filter flag and the retraining flag are true, the retrainer 1130 may retrain the deep learning-based in-loop filter.

For example, the retrainer 1130 may update the parameters within the deep learning module using the supervised learning method described above. In the example of FIG. 12, a loss function L is defined by Equation 4 based on the difference between the current sample x_{rec} and the corresponding output x_{rec_f}.

$$L = E {\vert {x}_{r e c} - {x}_{rec \_ f} \vert}^{2} \qquad [ Equation 4 ]$$

The retrainer 1130 may calculate the gradient value in a direction of reducing the loss function and then may update the parameters within the deep learning module using the SGD algorithm.

In another example, the retrainer 1130 may use a pre-decoded block as a target block by replacing the corresponding output x_{rec_f} in Equation 4. For example, a block co-located with the current sample in the reference frame of the current sample may be used as the target block. In the case of inter prediction, a reference block indicated by the motion vector of the current sample in the reference frame may be used as the target block. In the case of intra prediction, a prediction block searched for in the current frame according to template matching based on the template of the current sample may be used as the target block. Alternatively, a block generated by a weighted sum of all or part of the output x_{rec_f}, the co-located block, and the reference block indicated by the motion vector may be used as the target block. Alternatively, a block generated by a weighted sum of the output x_{rec_f} and the prediction block searched for according to template matching may be used as the target block.

In another example, the retrainer 1130 may update the parameters in the deep learning module using the contrastive learning. The block selected by the video block sampler 1120 is used as a positive sample. Also, the block not selected by the video block sampler 1120 may be used as a negative sample. Thereafter, a positive pair may be generated by combining two positive samples. Also, a negative pair may be generated by combining one positive sample and one negative sample. The retrainer 1130 may update the parameters in the deep learning module using the loss function of Equation 1 based on the generated positive pairs and negative pairs. In Equation 1, for example, f( ) may be a deep learning-based in-loop filter. Therefore, the similarity of a positive pair may be defined as the similarity between outputs generated by inputting positive samples constituting a positive pair into the in-loop filter. Also, the similarity of a negative pair may be defined as the similarity between the outputs generated by inputting the samples constituting the negative pair into the in-loop filter.

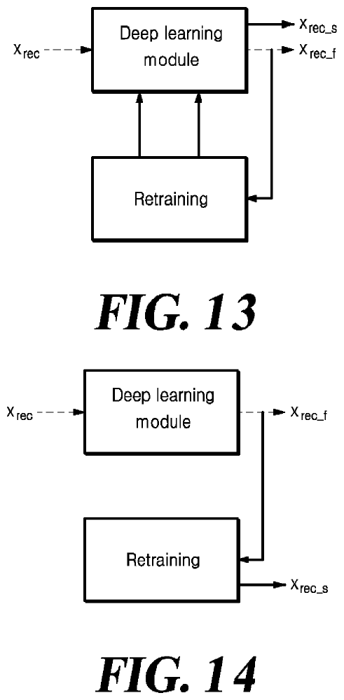

Meanwhile, one deep learning module may be used when the in-loop filter is retrained. The retrainer 1130, as shown in the example of FIG. 13, inputs the current sample x_{rec} into the existing deep learning module to generate x_{rec_f}. Thereafter, the retrainer 1130 may use the input and/or output of the deep learning module for retraining based on a learning method employed. The retrainer 1130 applies the updated parameters to the existing deep learning module during the retraining process. In the example of FIG. 13, the output x_{rec_s} represents the output of the updated deep learning module.

In another example, two deep learning modules may be used when retraining the in-loop filter. Hereafter, the two deep learning modules are represented as a first deep learning module and a second deep learning module. The first deep learning module represents the existing deep learning module. In the initial state, the first deep learning module and the second deep learning module include the same parameters.

The retrainer 1130 inputs the current sample x_{rec} into the first deep learning module, as illustrated in the example of FIG. 14, to generate x_{rec_f}. Thereafter, the retrainer 1130 may use the input and/or output of the deep learning module for retraining based on a learning method employed. The retrainer 1130 applies the updated parameters to the second deep learning module during the retraining process. In the example of FIG. 14, the output x_{rec_s} represents the output of the updated second deep learning module. In the example of FIG. 14, in addition to the retrained parameters, parameters of the previously used deep learning module may be preserved. In the example of FIG. 13, the current deep learning module is used after being updated, and in the example of FIG. 14, both the first deep learning module and the second deep learning module may be used.

The retrainer 1130 may use the updated parameters without modification. Alternatively, the retrainer 1130 may calculate the weighted average of the existing parameters and the updated parameters and use the weighted average parameters.

The samples used for retraining of the deep learning module may be stored in video sequence units and then used for retraining. Alternatively, samples used for retraining may be stored in picture, slice, or block units and then used for retraining.

As described above, VVC employs model-based in-loop filters such as ALF 566 and SAO 564. At this time, the video encoding device derives model parameters using the original video image and then transmits the derived parameters to the video decoding device. In the followings, using the ALF 566 as an example, a method by which the video decoding device derives model parameters using reconstructed images is described.

For the ALF described above, the video encoding device may derive the i-th filter coefficient ci according to Equation 5.

$${c}_{i} = arg min E ( x - {\sum }_{i = 0}^{N - i} {y}_{i} {c}_{i} ) \qquad [ Equation 5 ]$$

In Equation 5, N represents the number of filter coefficients. x represents the pixel value of the original image, and yᵢ represents the pixel value of a reconstructed image before being input to the ALF, which corresponds to the filter coefficient ci.

The video decoding device may generate the updated filter coefficient ci using the pixel value x^{j} corresponding to the output of the existing ALF instead of x in Equation 5.

For example, if the ALF flag is true, the ALF within the video decoding device generates an improved output from the pixel values of the reconstructed image. At this time, the video decoding device may update the ALF filter coefficients by using the pixel value x^{j} corresponding to the output of the existing ALF for the subsequent input video signals. Alternatively, the improved ALF may also be used for the current sample.

Meanwhile, the video encoding device may control the update of filter coefficients in the video decoding device using a flag (hereafter, “ALF update flag”) indicating whether to update the ALF. Depending on whether the encoding efficiency may be improved by updating the filter coefficients using the ALF output available on the decoder side, the video encoding device may set the value of the ALF update flag. At this time, if the ALF update flag is 0 in slice units or block units, the video decoding device does not update the filter coefficients but determines whether to apply the ALF based on the flag indicating whether to apply the ALF. On the other hand, if the ALF update flag is 1, the video decoding device may update the filter coefficients. At this time, the flag indicating whether to apply the ALF also has to be 1. In other words, if the flag indicating whether to apply the ALF is true and the ALF update flag is true, the video decoding device may perform update of the filter coefficients.

As described above, instead of deriving the filter coefficients of the ALF using the original image and then transmitting the corresponding coefficients, the video encoding device determines whether to use the updated filter coefficients on the decoder side. Also, the video encoding device may set the value of the ALF update flag according to the determination result and then signal the ALF update flag to the video decoding device.

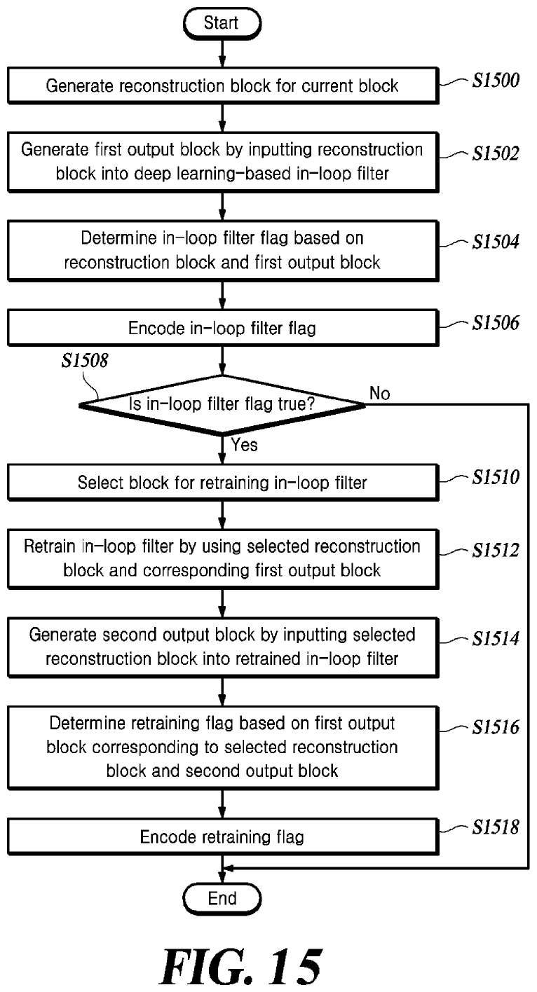

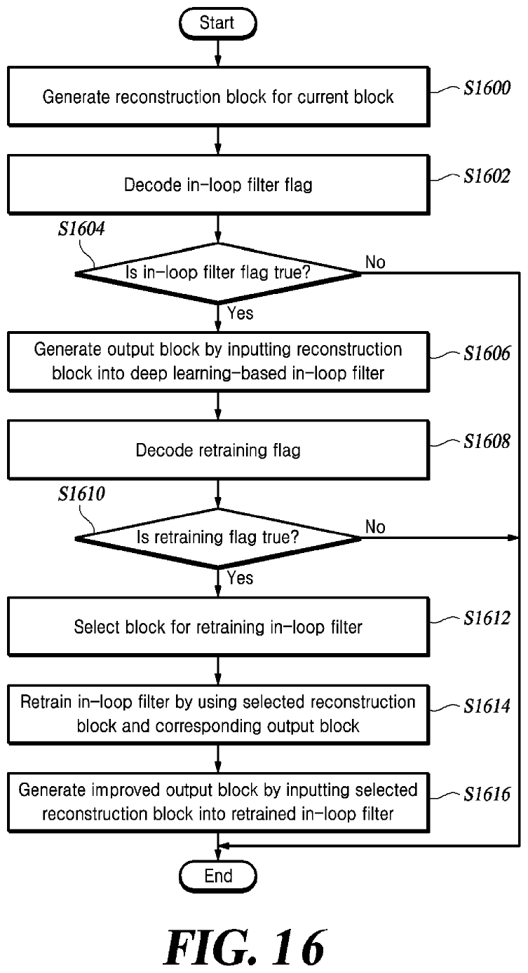

In the followings, with reference to FIGS. 15 and 16, a method for retraining a deep learning-based in-loop filter on the decoder side by the video encoding device or the video decoding device will be described.

FIG. 15 is a flow diagram illustrating a method for encoding a current block performed by a video encoding device according to one embodiment of the present disclosure.

The video encoding device generates a reconstruction block for the current block (S1500).

The video encoding device inputs the reconstruction block into a deep learning-based in-loop filter to generate a first output block (S1502). Here, the in-loop filter is pre-trained to generate an output that approximates the original block from the reconstruction block.

The video encoding device determines the in-loop filter flag based on the reconstruction block and the first output block (S1504).

The video encoding device may determine the value of the in-loop filter flag to optimize rate-distortion. For example, if the reconstruction block is optimal, the video encoding device sets the in-loop filter flag to false. On the other hand, if the first output block is optimal, the video encoding device may set the in-loop filter flag to true.

The video encoding device encodes the in-loop filter flag (S1506).

The video encoding device checks the in-loop filter flag (S1508).

If the in-loop filter flag is true (Yes in S1508), the video encoding device performs the subsequent steps (S1510 to S1518). On the other hand, if the in-loop filter flag is false (No in S1508), the video encoding device may omit the steps of retraining the in-loop filter.

The video encoding device selects a block for retraining the in-loop filter from the reconstruction block (S1510).

The video encoding device retrains the in-loop filter by using the selected reconstruction block and the corresponding first output block (S1512).

If retraining is performed based on the loss function shown in Equation 4, the video encoding device may use a pre-decoded block as a target block by replacing the corresponding output block. For example, a block at a position corresponding to the current sample in the reference frame of the current sample may be used as the target block. In the case of inter prediction, a reference block indicated by the motion vector of the current sample in the reference frame may be used as the target block. In the case of intra prediction, a prediction block searched for in the current frame according to template matching based on the template of the current sample may be used as the target block.

The video encoding device inputs a selected reconstruction block into the retrained in-loop filter to generate a second output block (S1514).

Alternatively, the video encoding device may apply the retrained in-loop filter to a reconstruction block selected after the current block. In other words, the video encoding device may generate a first output block and a second output block for a reconstruction block selected after the current block.

The video encoding device determines a retraining flag based on the first output block corresponding to the selected reconstruction block and the second output block (S1516).

The video encoding device may determine the value of the retraining flag to optimize the rate distortion. For example, if the first output block is optimal, the video encoding device sets the retraining flag to false. On the other hand, if the second output block is optimal, the video encoding device may set the retraining flag to true.

The video encoding device encodes the retraining flag (S1518).

FIG. 16 is a flow diagram illustrating a method for reconstructing a current block performed by a video decoding device according to one embodiment of the present disclosure.

The video decoding device generates a reconstruction block for the current block (S1600).

The video decoding device decodes an in-loop filter flag from a bitstream (S1602).

The video decoding device checks the in-loop filter flag (S1604).

If the in-loop filter flag is true (Yes in S1604), the video decoding device may use the deep learning-based in-loop filter. On the other hand, if the in-loop filter flag is false (No in S1604), the video decoding device may not use the in-loop filter.

The video decoding device generates an output block by inputting a reconstruction block for the current block into the deep learning-based in-loop filter (S1606). Here, the in-loop filter is pre-trained to generate an output that approximates the original block from the reconstruction block.

The video decoding device decodes the retraining flag from a bitstream (S1608).

The video decoding device checks the retaining flag (S1610).

If the retraining flag is true (Yes in S1610), the video decoding device may perform the steps (S1612 to S1616) of retraining the in-loop filter. On the other hand (No in S1610), if the retraining flag is false, the video decoding device may omit the steps of retraining the in-loop filter.

The video decoding device selects a block for retraining the in-loop filter from the reconstruction block (S1612).

The video decoding device retrains the in-loop filter by using the selected reconstruction block and the corresponding output block (S1614).

If retraining is performed based on the loss function shown in Equation 4, the video decoding device may use a pre-decoded block as a target block by replacing the corresponding output block. For example, a block at a position corresponding to the current sample in the reference frame of the current sample may be used as the target block. In the case of inter prediction, a reference block indicated by the motion vector of the current sample in the reference frame may be used as the target block. In the case of intra prediction, a prediction block searched for in the current frame according to template matching based on the template of the current sample may be used as the target block.

The video decoding device inputs a selected reconstruction block into the retrained in-loop filter to generate an improved output block (S1616).

Alternatively, the video decoding device may apply the retrained in-loop filter to a reconstruction block selected after the current block. In other words, the video decoding device may generate an improved output block for the selected reconstruction block selected after the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

510: inverse transformer
540: predictor
560: a loop filter unit
566: ALF
1110: video block decoder
1120: video block sampler
1130: retrainer

1. A method for reconstructing a current block, performed by a video decoding device, the method comprising:
generating a reconstruction block for the current block from a bitstream;
generating an output block by inputting the reconstruction block to a deep learning-based in-loop filter, wherein the in-loop filter is pre-trained to generate an output that approximates original block from the reconstruction block;
selecting a block for retaining of the in-loop filter from the reconstruction block; and
retraining the in-loop filter by using the selected reconstruction block and a target block.

2. The method of claim 1, further comprising:
decoding an in-loop filter flag from the bitstream; and
checking the in-loop filter flag,
wherein, when the in-loop filter flag is true, generating the output block is performed.

3. The method of claim 1, further comprising:
decoding a retraining flag from the bitstream; and
checking the retraining flag,
wherein, when the retraining flag is true, selecting the block for retraining and retraining the in-loop filter are performed.

4. The method of claim 3, when the retraining flag is true, further including:
generating an improved output block by inputting the selected reconstruction block to the retrained in-loop filter.

5. The method of claim 1, wherein selecting the block for retraining comprises:
determining whether to select the reconstruction block as a block for retraining based on parameters used for compression of the reconstruction block.

6. The method of claim 1, further comprising:
decoding section information to which the retraining is applied from the bitstream,
wherein, selecting the block for retraining comprises:
when the reconstruction block is included in the section information, selecting the reconstruction block as a block for retraining.

7. The method of claim 1, wherein selecting the block for retraining comprises:
generating an output by inputting the reconstruction block to a pre-trained discriminator and determining whether to select the reconstruction block as a block for retraining based on the output of the discriminator.

8. The method of claim 1, wherein the target block is an output block corresponding to the selected reconstruction block, a block co-located with the current block in a reference frame of the current block, a reference block indicated by a motion vector of the current block, or a prediction block searched for in a current frame according to template matching based on a template of the current block.

9. The method of claim 1, wherein retraining the in-loop filter comprises:
defining a loss function based on a difference between the selected reconstruction block and the target block and updating parameters of the in-loop filter in a direction of reducing the loss function.

10. The method of claim 1, wherein the in-loop filter includes a first deep learning module and a second deep learning module that include same parameters in an initial state;
wherein generating the output block comprises:
generates the output block from the reconstruction block by using the first deep learning module,
wherein retraining the in-loop filter comprises:
updating parameters of the second deep learning module by using the selected reconstruction block and the target block.

11. A method for encoding a current block, performed by a video encoding device, the method comprising:
generating a reconstruction block for the current block;
generating a first output block by inputting the reconstruction block to a deep learning-based in-loop filter, wherein the in-loop filter is pre-trained to generate an output that approximates original block from the reconstruction block;
selecting a block for retaining of the in-loop filter from the reconstruction block;
retraining the in-loop filter by using the selected reconstruction block and a target block; and
generating a second output block by inputting the selected reconstruction block to the retrained in-loop filter.

12. The method of claim 11, further comprising:
determining an in-loop filter flag based on the reconstruction block and the first output block; and
encoding the in-loop filter flag.

13. The method of claim 12, further comprising:
checking the in-loop filter flag,
wherein, when the in-loop filter flag is true, selecting the block for retraining, retraining the in-loop filter, and generating the second output block are performed.

14. The method of claim 12, further comprising:
determining a retraining flag based on a first output block corresponding to the selected reconstruction block and the second output block; and
encoding the retraining flag.

15. The method of claim 11, wherein the target block is a first output block corresponding to the selected reconstruction block, a block co-located with the current block in a reference frame of the current block, a reference block indicated by a motion vector of the current block, or a prediction block searched for in a current frame according to template matching based on a template of the current block.

16. A computer-readable recording medium storing a bitstream generated by a video encoding method, the video encoding method comprising:
generating a reconstruction block for a current block;
generating a first output block by inputting the reconstruction block to a deep learning-based in-loop filter, wherein the in-loop filter is pre-trained to generate an output that approximates original block from the reconstruction block;
selecting a block for retaining of the in-loop filter from the reconstruction block;
retraining the in-loop filter by using the selected reconstruction block and a target block; and
generating a second output block by inputting the selected reconstruction block to the retrained in-loop filter.
